(19) United States
(12) Patent Application Publication
(10) Pub. No.: US 2002/0032853 A1
(43) Pub. Date: Mar. 14, 2002

(54) Secure dynamic link allocation system for mobile data communication

(76) Inventors: Dan A. Preston, Bainbridge Island, WA (US); R. Pierce Lutter, Tacoma, WA (US); Mitch A. Benjamin, Renton, WA (US); Tracey J. Olson, Auburn, WA (US); Harris O. Hinnant, Seattle, WA (US)

Correspondence Address: STOEL RIVES LLP, 900 SW FIFTH AVENUE, SUITE 2600, PORTLAND, OR, 97204, US

(21) Appl. No.: 09/837,563

(22) Filed: Apr. 17, 2001

Related U.S. Application Data
(60) Provisional application No. 60/198,068, filed on Apr. 17, 2000.
(60) Provisional application No. 60/211,694, filed on Jun. 14, 2000.
(60) Provisional application No. 60/215,378, filed on Jun. 29, 2000.

(51) Int. Cl. H04L 9/00

(52) U.S. Cl. 713/151; 380/270

(57) ABSTRACT

Systems and methods are disclosed for layered, secure data communications with a mobile unit over a variety of different communication links, such as in-band signalling, SMS, CDPD etc. A privilege control table determines permitted classes of messages. Content labeling is used to further manage communications without reading the payload of the message. The invention adds additional layers of security by varying content labels based on secure session key exchange seeded algorithms. The system also includes isolating the application program by providing a protocol manager for exclusive receipt of a communication service request from the application program; the protocol manager implementing a plurality of different message protocols. Another aspect of the invention includes link choose logic for effecting loosely-coupled, network loop communications to enable broadband delivery to a mobile unit, and can include parallel transmission of segmented messages over plural communication links.

### BACKGROUND OF THE INVENTION

Most secure data communication methods are designed to preserve the confidentiality of data being transmitted over communication networks, such as telephone networks, the Internet, wireless data transmission systems, and other digital data transmission systems and networks. These methods of secure data transmission include data encryption and decryption algorithms that use long randomly-generated cipher keys. However, encryption of data and messages cannot ensure that the message sender is truly whom he or she holds himself or herself out to be. In other words, cryptography does not authenticate the sender.

For example, to use public key encryption (PKE), the intended recipient must first issue a public encryption key that a prospective sender can use to encrypt a message for delivery to the intended recipient. The message is decryptable only with a private encryption key (the complement of the public key) known only to the intended recipient. A public encryption key distributed over a public network is vulnerable to interception by an eavesdropper. Thus, a recipient of data encrypted using PKE cannot be certain of a sender's identity because an encrypted message can be generated by anyone who has obtained access to the public key.

Various methods are known for authentication of a sending computer. These methods typically employ digital signature algorithms or security certificates authenticated by trusted third parties.

Known encryption, digital signature, and certificate authentication methods are susceptible to playback, middleman, code book, cryptanalysis attacks through monitoring of network traffic associated with the sending and receiving computers or by impersonation of a trusted third party or certificate holder.

Some types of attacks on communications security affect the integrity of the communication rather than its confidentiality. For instance, denial-of-service attacks can disable a receiving node by flooding it with unauthorized messages. Integrity attacks are most harmful when the timely and accurate receipt of a secure communication is important.

U.S. Pat. No. 5,530,758 of Marino, Jr. et al. describes a system and method of secure communication between software applications running on two trusted nodes, which are coupled by an unsecure network link. A simple method of authenticating a sending node is also described. A trusted interface of each trusted node acts as a gateway for all messages sent from or received by applications running on the trusted node. The trusted interface applies security restrictions defined by an identity based access control table (IBAC table), which is predefined for each node by a security administrator. The IBAC table stored at a node lists addresses of trusted nodes to which the local applications are authorized to send messages and from which the local applications are authorized to receive messages. Secure communication is established between trusted nodes in response to a service requests made by the applications. After verifying that a service request designates a remote node listed in the IBAC table, the trusted interface initializes a secure communications channel in cooperation with security kernels of the trusted nodes. The initialization sequence includes an exchange of security certificates and communication security attribute information between the security kernels, which is then used by each node to authenticate the other and to establish a security rating for the channel. Following authentication, the security kernels of the trusted nodes exchange traffic encryption keys which are used for encryption of subsequent data transmitted over the channel.

A need exists for an improved method and system for secure data transmission that is designed to ensure the confidentiality, authenticity, integrity, and non-repudiation of message traffic. A need also exists for such a system that can be deployed in stages to achieve progressively better security as the need arises.

U.S. Pat. No. 6,122,514 to Spaur et al. describes methods of communication channel selection, taking into account the requirements of each application program intended to communicate over one or more available channels. According to the Spaur et al. patent, an application program is designed to provide its applications requirements either dynamically, as the application executes, or statically, at the time of application installation, to the “network channel selection apparatus 14.” See column 5, lines 49 et seq. and FIG. 1. These “requirements” relate to cost factors, transfer rates, etc.

One problem with the approach taught by Spaur et al. is that every application program must be custom designed, or modified, to interact with the network channel selection apparatus as described. This approach is cumbersome, expensive and violates the very essence of interoperability enabled by a layered approach such as the OSI model. The need remains for intelligent link management that is transparent to the application, so that standard “off the shelf” applications can be effectively deployed in the wireless environment. Similarly, at the network interface or link layer level, Spaur et al. teach a link controller/monitor connected to the network interface hardware (FIG. 1). The specification explains:

“The network channel selection apparatus 14 also includes a link controller/monitor 50 that is operatively connected to the network interfaces 30 for receiving information therefrom and making requests thereto. In particular, the link controller/monitor takes responsibility for the control and status of the of the network channels 34a-34n. It maintains a status watch of each such channel by means of its communication with the network interfaces 30. The monitoring process is network channel dependent.”

U.S. Pat. No. 6,122,514 at column 9, lines 35 et seq.

Consequently, it appears that the network interfaces also must be custom designed, or modified, to interact with the link controller/monitor 50 as described. This approach is cumbersome, expensive and violates the very essence of interoperability enabled by a layered approach such as the OSI model. The need remains for intelligent link management that is isolated from and transparent to link channels, so that standard “off the shelf” hardware and software components can be employed. Another limitation of the prior art is that a single communication or “session” is limited to a single communication link outbound, and optionally a second link inbound. The need for improvements in communication efficiency remains.

### SUMMARY OF THE INVENTION

Systems and methods are disclosed for layered, secure data communications with a mobile unit over a variety of different communication links, such as in-band signalling, SMS, CDPD etc. A privilege control table determines permitted classes of messages, each class corresponding to a predetermined combination of a selected sending application, a selected destination application and a selected message type. Content labeling is used to further manage communications without reading the payload of the message. The invention adds additional layers of security by varying content labels based on secure session key exchange seeded algorithms. The system also includes isolating the application program by providing a protocol manager for exclusive receipt of a communication service request from the application program; the protocol manager implementing a plurality of different message protocols for establishing corresponding virtual socket connections with various application programs. Another aspect of the invention includes link choose logic for effecting loosely-coupled, network loop communications to enable broadband delivery to a mobile unit, and can include parallel transmission of segmented messages over plural communication links.

In accordance with the present invention, a security manager is implemented in computer software, firmware, or hardware for use in conjunction with a data communication device. The security manager is useful for securely transmitting data from an application software program to another computer or software program and for verifying the authenticity and integrity of data addressed to the application software program.

The security manager includes multiple subsystems that are applied cumulatively to data being transmitted between the data communication device and a remote device. The security subsystems can include encryption, content labeling, source identification, and data integrity subsystems and any combination thereof. The security manager is adapted to manage and apply security subsystems in a modular environment. Because security subsystems are implemented as independent modules of the security manager system, they can be deployed when developed and then revised as needed during the life of the data communication device. Modular security subsystems also allow device manufacturers and network operators to implement security improvements in progressive phases to spread the cost and complexity over time. With enough security, the system can provide a foundation for users to establish and protect their personal digital identity.

In one embodiment, the security manager initiates an authentication sequence and public key exchange between the data communication client and a data server. The authentication sequence and key exchange occurs over a first data communication link, which is preferably an in-band signaling channel operating over a voice channel of wireless communication device such as a cellular telephone. In-band signaling is preferred because the telephone networks over which it can be used are more widely available than other communication links (e,g., Bluetooth™, satellite broadband, infrared, CDPD, etc.). Furthermore, encryption key exchange is critical to operation of the security manager, and is best accomplished through the use of a proprietary protocol such as in-band signaling, rather than a widely recognized protocol such as TCP/IP or Bluetooth™. After the key exchange is complete, the security manager is enabled to encrypt outgoing messages and decrypt incoming messages.

A second data communication link preferably different from the first data communication link is utilized for transferring encrypted message payload. In a further embodiment, the message payload is spread over several links, which may include the first data communication link and others. More specifically, a message is divided into multiple packets, but the packets are then allocated or “spread” over two or more different communication links. This strategy enhances the difficulty of an unauthorized third party intercepting and reconstructing the message.

Realizing another layer of security, allowable inbound and outbound messages are defined in a Privilege Control Table (PCT) that is stored in non-volatile read/write memory accessible by the security manager. A content label included in each transmission received by the security manager is verified against the PCT to authenticate the sender and message type before delivering the payload of the transmission to an authorized recipient user application. For each user application to which the security manager delivers message, the PCT includes entries for authorized combinations of source application, message code, message size, and security rating. Each entry combination is listed in the PCT along with a corresponding content label. Such content labels need not be static, however. A further aspect of the invention provides for re-ordering or reassigning content labels to PCT entries, again providing another layer of security. Reordering or reassigning content labels is managed by predetermined algorithms implemented in both the sending and receiving nodes that utilize a shared private key generated by each of the nodes following a public key exchange.

Preferably, the security manager, the application software program, and the data communication device are all implemented on a computer system, such as a personal computer, cellular telephone, personal data assistant, handheld wireless communication device, or other devices including a digital computing device. However, the components of the invention may also be distributed over different devices with secure interconnections, which, when viewed as a unit comprise a node of the secure system.

The computer system or other communication device has access to one or more communication network links (typically unsecured) or other digital data or audio data communication links for communicating with remote devices or systems. A link manager protocol is operable on the computer system of the present invention for choosing the appropriate communication network link based on cost, priority, security, and availability of the various types of network links and the cost, priority, and security required by the application or the security manager. The link manager can also be configured to spread messages over several network links in accordance with cost, priority, and security requirements of the application, and to balance loads across the available links.

Unlike the link manager of Spaur et al., the system of the present invention is made transparent to applications by isolating the application from the link manager rather than directly interconnecting the two as taught by Spaur et al. According to the present invention, link management focuses on the message, not the messenger. It is transparent to the application, and does not require any special or proprietary API.

Prior art link management focuses on selection of an appropriate link or channel to send a message, based on the sending application's requirements, as noted above. Improvements in communication security and performance can be achieved by managing use of plural channels in parallel when appropriate. In addition, the prior art focuses on a point-to-point link or links, i.e. communication between a sender and a receiver. However, new and improved features can be implemented in the context of a more broadly defined, loosely coupled network, in which initial communications, e,g., between a mobile unit and a first server, begin a process that results in a separate but related broadcast communication from a second server to the mobile unit, thereby completing a loop topology. In one embodiment, the loop topology established includes non-uniform loop segments using different transmission methoodologies. In this arrangement, a broadband transmitter, e.g. a satellite-borne or road-side transmitter, can form the final link in such a communication loop that begins with another link, such as an in-band signaling link. The broadband link is adapted for delivery of data at high bandwidths that the mobile unit is capable of receiving but not transmitting. This loosely coupled networking method can be used for a mobile unit to receive, for example, video content or the like. This approach can also be used to bypass (actually pass through) the usual wireless voice services so that they unwittingly (and without surcharge) provide a pathway for initiating a link in the broadband network for delivery of data to the mobile unit.

Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 is an interconnection diagram showing an overview of a system software program implemented in a sending node and a receiving node to form a secure dynamic link allocation system for mobile data communication in accordance with the present invention;

FIGS. 2A and 2B are schematic diagrams showing the software architecture of the system software of FIG. 1, in operation on the respective sending and receiving nodes and depicting a message generated at the sending node as processed by the system software at the sending node for transmission to the receiving node and, upon receipt at the receiving node, as processed for presentation to an application of the receiving node;

FIG. 2C is a schematic diagram illustrating operation of a link manager of the system software of FIG. 1 and its interface with network link controllers;

FIG. 3 is a flowchart showing the steps performed by the system software of FIG. 1 operating on a sending node, as depicted in FIGS. 2A, 2B and 2C;

FIG. 4 is a conceptual diagram of the system software and secure dynamic link allocation system of FIG. 1 shown, with reference to the Open Systems Interconnect model (“OSI model”), being implemented for loosely coupled networking over various physical network links in accordance with the present invention;

FIG. 5 is a simplified block diagram showing a hardware architecture of a mobile communication node for implementing the secure dynamic link allocation system of FIG. 1 in a motor vehicle, in accordance with a preferred embodiment the present invention;

FIG. 6 is a flowchart depicting the steps performed in establishing a secure communication session between the mobile node of FIG. 5 and a call center node operating the secure dynamic link allocation system of FIG. 1;

FIG. 7 is a flowchart depicting the steps of an encryption key exchange and digital signature authentication at the call center node of FIG. 6;

FIG. 8 is a flowchart depicting the steps of an encryption key exchange and digital signature authentication at a mobile node in accordance with the method depicted in FIG. 6;

FIGS. 9A, 9B, and 9C are examples of Privilege Control Tables (PCTs) in accordance with the present invention for implementing a content labeling and verification process of the secure dynamic link allocation system of FIG. 1 as referenced in FIGS. 2A, 2B, 2C, 3, and 6; and

FIG. 10 further illustrates the link allocation and loosely-coupled networking methods of FIGS. 3-5.

### DETAILED DESCRIPTION OF PREFERRED EMBODIMENTS

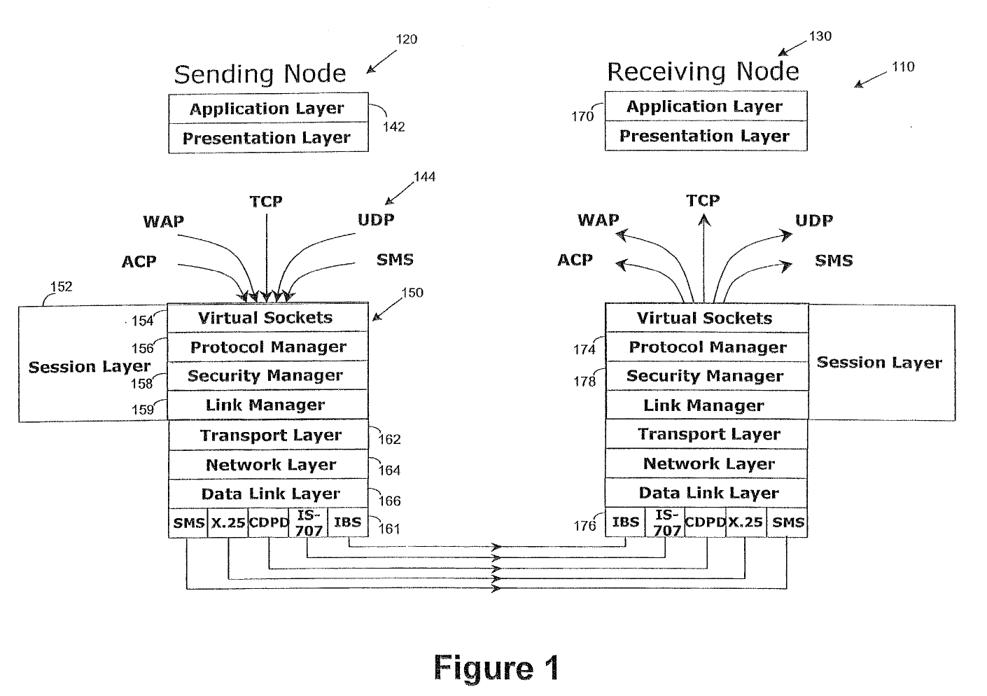

FIG. 1 is an interconnection diagram showing a secure dynamic link allocation system 110 for mobile data communication (hereinafter “the communication system”), in accordance with the present invention. With reference to FIG. 1, a sending node 120 establishes communication with a receiving node 130. Sending node 120 and receiving node 130 can be implemented on any of a variety of hardware platforms using either widely available software or customized software. Sending node 120 and receiving node 130 include symmetric software components that are represented in FIG. 1 by the generic layers of the Open Systems Interconnect model (“OSI model”). Although FIG. 1 depicts transmission of message data from sending node to receiving node, communication can be either one-way or two-way in operation. One or more applications run on sending node 120 as represented by application layer 142. The applications generate messages for transmission using one of several widely available communication protocols 144, such as a ACP, WAP, TCP, UDP, SMS, and others.

A sending system software 150 is preferably implemented in a session layer 152, and includes a set of virtual sockets 154 corresponding to transport services typically provided by standard transport software implementing the communications protocols 144. Virtual sockets 154 are transparent to applications running in application layer 142 in that messages passed to virtual sockets 154 by the applications are handled as if virtual sockets 154 were operating as transport services. However, virtual sockets 154 handle messages differently from transport software associated with a particular link. Rather, virtual sockets 154 work in conjunction with a protocol manager 156 and a security manager 158, and a link manager 160 of sending system software 150 to isolate applications running in application layer 142 from various communications network transmission systems and links 161 accessed through standard networking software operating in the transport layer 162, the network layer 164, and/or the data link layer 166.

One or more receiving applications run in a receiving application layer 170 of receiving node 130. A receiving system software 174 is implemented on receiving node 130 similar to sending system software 150 operating on sending node 120. In accordance with the present invention, messages processed by sending system software 150 are received over one or more of various inbound links 176 at receiving node 130, then handled by receiving system software 174 to reassemble, verify security, and decode messages as needed. Receiving system software 174 then routes the processed messages to the appropriate applications running in receiving application layer 170. In this manner, communications system 110 can be implemented in a manner transparent to standard application software and data communication and networking software.

Security Manager 158 of sending system software 150 is adapted to establish a secure session with receiving node 130 through coordination with a receiving security manager 178. Sending security manager 158 can bypass security measures if secure transmission is not indicated by the type of message and if receiving node is not configured with receiving system software to establish secure communication.

The communications system 110 can be deployed to nodes that are already in service using a portable platform-neutral application language such as Java.

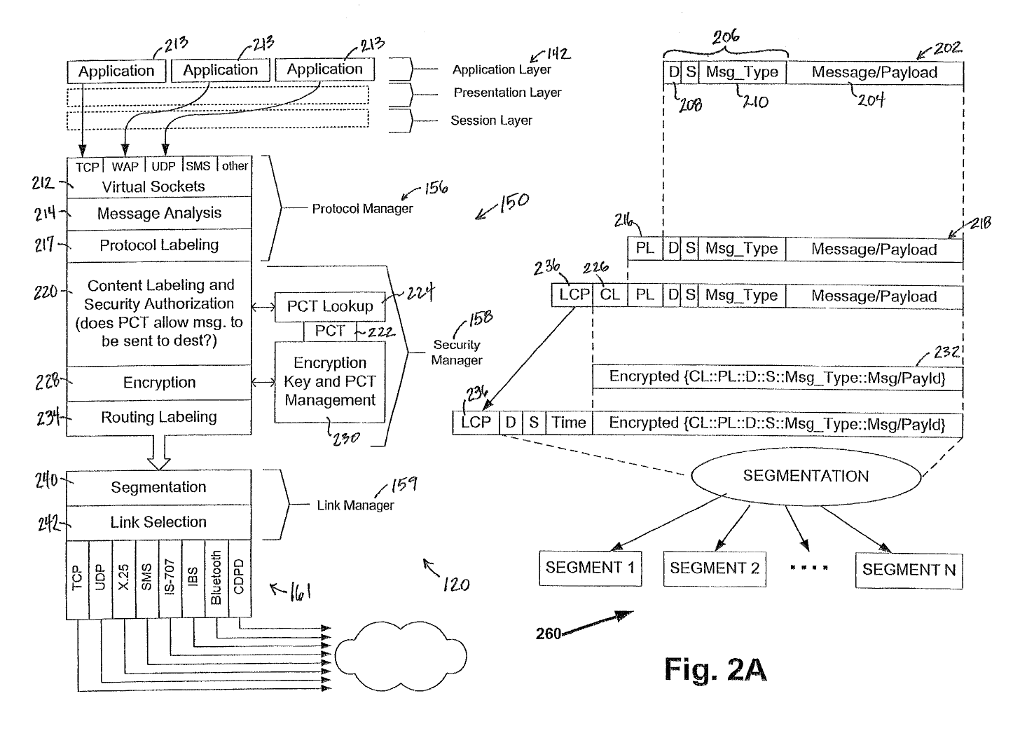

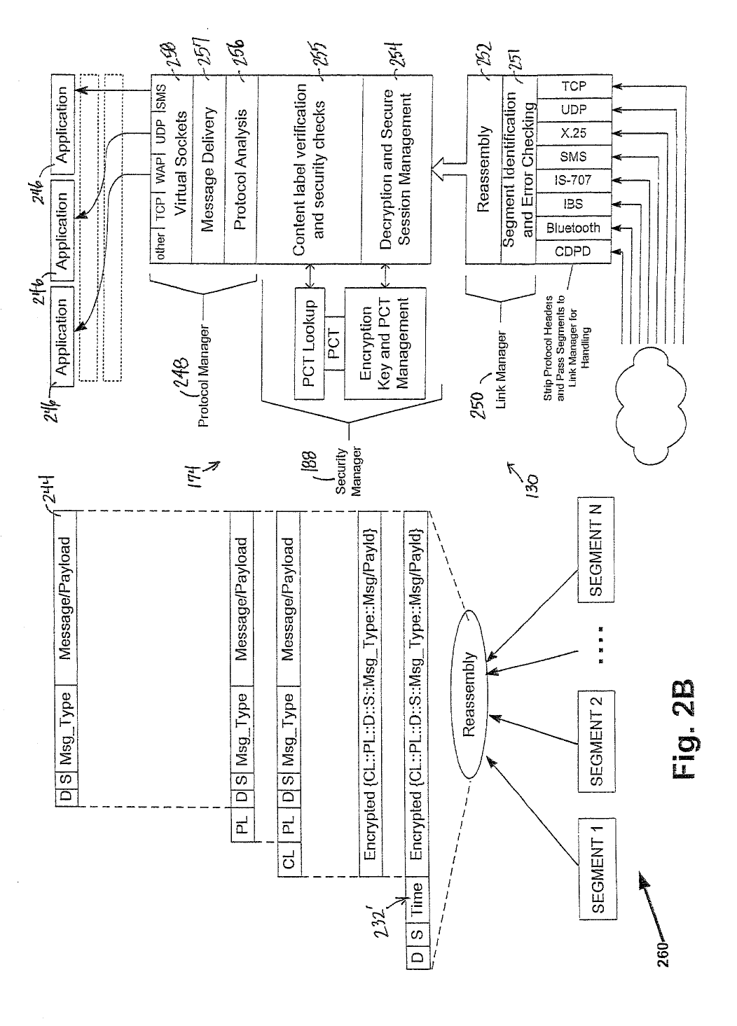

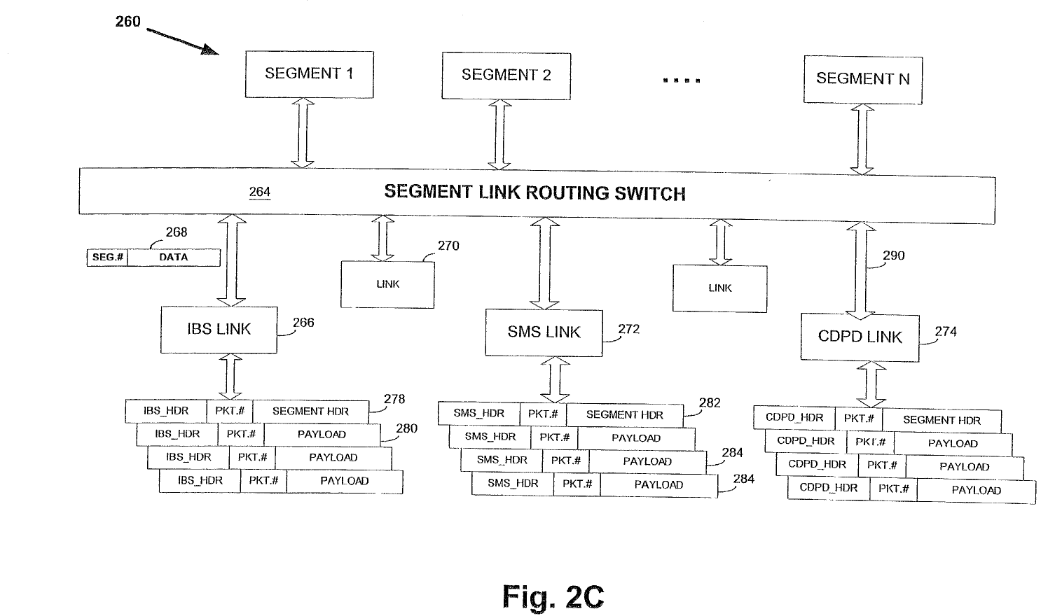

FIG. 2A is a schematic diagram showing software architecture of system software 150 operating on the descending node 120 of FIG. 1. In the right side of FIG. 2A, a message 202 directed to the receiving node 130 (FIG. 1) is shown being processed by the sending system software 150 before transmission to receiving node 130. With reference to FIG. 2A, message 202 includes a message payload 204 and a messager header 206 including a destination indicator 208 and a message-type field 210. Allowable message types are predefined for each application during the application's development and certification in the context of the secure communication system.

Protocol manager 156 includes virtual sockets 212 corresponding to any of a variety of standard transport services supported by sending node 120, such as TCP, WAP, UDP, SMS, and other transport services. Virtual sockets 212 are adapted to receive messages from applications 213 running in application layer 142, then pass the messages to a message analysis module 214 of protocol manager 156. Message analysis module 214 extracts destination, source, and message-type information from message 202 and determines a message size of message 202 and the virtual socket 212 on which message 202 was received. A protocol label 216 is then prepended to message 202 by protocol labeling module 217 to indicate the virtual socket 212 on which message 202 was received. The resulting protocol labeled message 218 is then passed by protocol manager 156 to security manager 158 for security authorization and handling.

A content labeling and security authorization module 220 of security manager 158 accesses a privilege control table (PCT) 222 using a secure PCT lookup function 224 to identify an entry in PCT 222 corresponding to the sending application 213, destination 208, message type 210 and the size of message 202. If an entry is found in PCT 222, PCT lookup function 224 returns to content labeling and security authorization module 220 a “content label” (CL) 226 corresponding to the entry in the privilege control table. If an entry is not found in PCT 222, then PCT lookup function 224 returns a default content label, which indicates to content labeling and security authorization module 220 that message 202 is not authorized for transmission.

Protcol manager 156 and security manager 158 are also adapted to handle unsecure messages (not shown) generated by uncertified applications and which do not include message type information for lookup of content label information in PCT 222. If sending node 120 is configured to allow unsecure applications to send outgoing messages, then protocol manager 156 bypasses security manager 158 and presents link manager with an unsecure message for transmission on an appropriate link 161 of sending node 120.

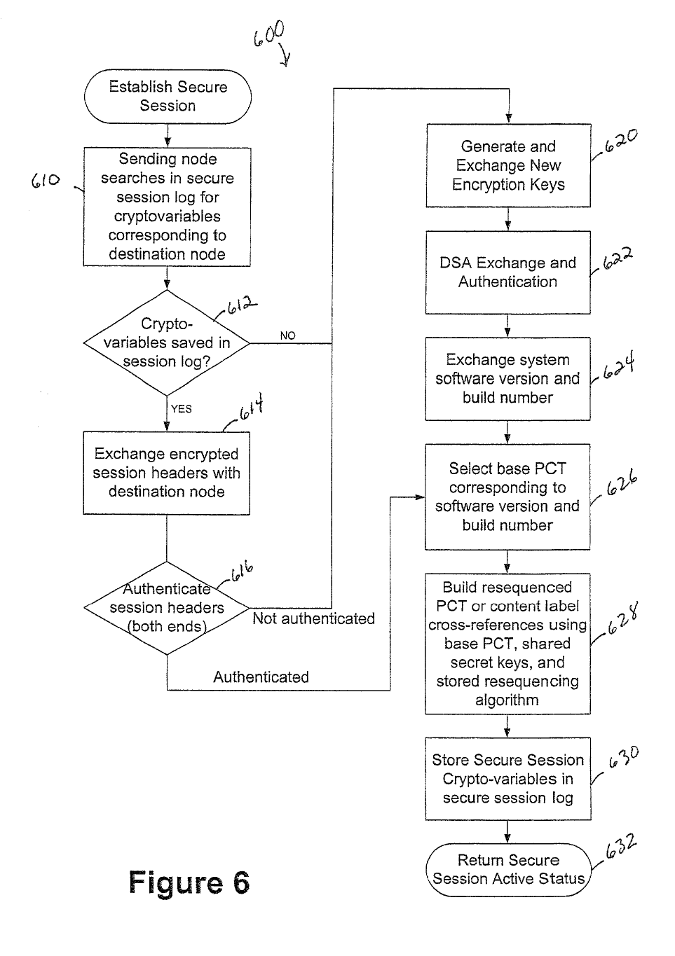

In secure mode, the protocol label message 218 is prepended with content label 226 before encryption by an encryption module 228 of security manager 158. Encryption module 228 uses encryption keys generated by an encryption key and PCT management module 230, which is described in greater detail below with reference to FIGS. 6-8. An encrypted content labeled message 232 is generated by encryption module 228 and passed to a routing labeling module 234 of security manager, which prepends destination, source, time, and link choose parameters (LCP) 236 to encrypted content labeling message 232.

Alternatively, LCP, destination, source, time, and other message routing and security related information can be passed directly to link manager 159, either as a header to encrypted content labeled message 232 or in parallel with the transfer of encrypted content labeled message 232.

Upon receipt of encrypted content labeled message 232, a segmentation module 240 of link manager can optionally segment the encryped message into one or more message segments 260. A link selection module 240 identifies available links 161 and chooses one or more appropriate links based on link choose parameters 236 and other attributes of the message 232. Link manager 159 then distributes message segments 262 to the selected links in accordance with the link selection methodology described below.

FIG. 2B is a schematic diagram showing software architecture at receiving node 130. The left side of FIG. 2B shows the evolution of received segments 260 of the message 202 transmitted by sending node 120 (FIG. 2A) as they are handled and reassembled to form a received message 244 delivered to one or more receiving node applications 246. With reference to FIG. 2B, receiving node software system 174 includes a receiving node security manager 188, a receiving node protocol manager 248, and a receiving node link manager 250. Protocol manager 248, security manager 188, and link manager 250 perform functions corresponding to protocol manager 156, security manager 158, and blink manager 159 of sending node 120, such as segment identification and error checking 251, reassembly of message segments 252, decryption and secure session management 254, content label verification and security authorization 255, protocol analysis 256, message delivery 257, and virtual sockets 258. Receiving node software system 174 can be implemented with software identical to sending node software system 150 to enable two-way synchronius or asynchrous communication between sending node 150 and receiving node 130.

Upon receipt of message segments 260, reassembly module 252 of link manager 250 uses header information (not shown) of message segments 260 to reassemble message segments 260 into encrypted content labeled message 232′. Segement identification and error checking module 251 of link manager 252 monitors the segment receipt and reassembly process to ensure that segments are not lost or corrupted during transmission. Encrypted content labeled message 232′ is then handled by security manager for decryption and content label verification to ensure that the unencrypted message 244 delivered to applications 246 is of a message type size and source application authorized for delivery to the designated receiving node application 246 identified in the message header.

FIG. 2C illustrates operation of the link manager component and its interface with the link controllers. First, logic in the link manager can segment a message into any number of segments, based on the communication links available, latency or queue size of each link, and the link choose parameters mentioned earlier such as priority, message size, and message type. Segmenting a message over two or more communication links has the potential for increased bandwidth as well as enhanced security. The link manager then directs each segment to a selected link. For example, as illustrated in FIG. 2C, the link manager can employ a segment link routing switch 264, which may be implemented in software and/or hardware. The link manager may direct a first segment to an IBS link 266. “IBS” refers to in band signaling, a technique for transmitting data at a low data rate within the voice channel of a wireless telephone communication link. Other links, for example link 270, may be unavailable at the present time, or the link manager may determine thank link 270 is inappropriate for the present message. Another segment may be routed by the link manager to an SMS link 272, referring here to the short message service provided by some wireless carriers. When the link manager routes a segment of data to a selected link, it appends a segment number to the data as shown at 268. In FIG. 2C, a third segment is routed to a CDPD link 274. Each of the link controllers 266, 272, 274, etc. may include a buffer and attends to the transmission tasks generally associated with the transport and network layers of the OSI model. Each data segment is treated by the link controller as a complete message. That message typically will be further partitioned into packets for transmission over the data link and physical layers. Thus, the IBS link controller 266 can partition the assigned segment into a plurality of packets, for example, packet 278. Each packet includes at least a header, packet number, and payload. The header is specific to the corresponding link type. So, for example, the header of packet 278 generated by the IBS link 266 is an IBS type of header.

The IBS link can also add a segment header as the payload in packet 278. The segment header includes information for reassembling the segments at the receiving node.

Similarly, the SMS link manager 272 generates a series of packets beginning with packet 282, and continuing with a series of payload packets indicated at 284. These specific headers, labels and protocols are not critical, and can be varied within the scope of the general functionality of the present invention. The interface between the link manager software and the various individual link controllers, illustrated for example at 290, includes status as well as data aspects. For example, the link controller reports to the link manager its availability, latency or queue size, and status of the requested transmission. This information is taken into account by the link manager in its decision making.

As indicated in FIG. 2B, the various segments of the transmitted message will be reassembled at the receiving node. The process is largely an “undoing” of the segmentation process undertaken at the sending node. Briefly, each communication link receives a series of packets which that link can then reassemble into a complete segment, optionally employing error checking and correction as are known in the art. Each link controller forwards the received segment, including the segment identification information (see 268) to the segment link routing switch 264. Based on the segment identifiers, the link manager logic controls the link routing switch to reassemble the complete message as indicated generally in the reassembly step in FIG. 2B.

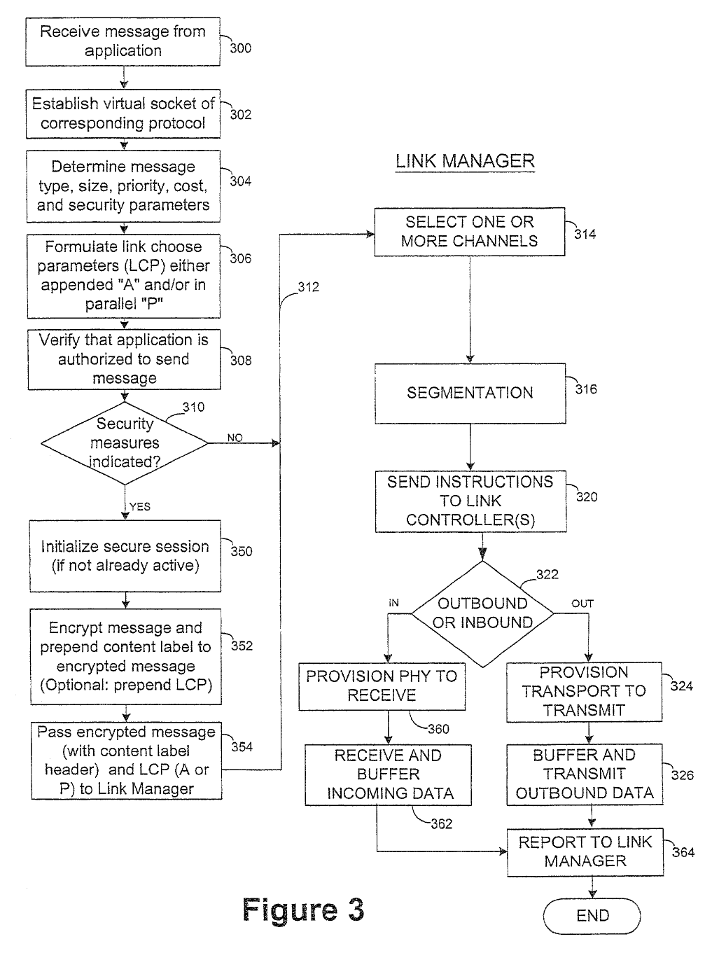

FIG. 3 is a high level flow chart illustrating in general the steps performed by the system software of FIG. 1. Referring to FIG. 3, the process begins upon receipt of a message from an application executing on the platform, step 300. A software isolation layer implements virtual sockets corresponding to the protocol in use by the application. In other words, if a given application expects to establish communication over a particular type of socket, a “virtual socket” of the selected protocol type can be implemented. Examples of virtual sockets, as illustrated in FIG. 2, include TCP, WAP, UDP, SMS and other protocols. For each message, an indicator of the corresponding socket type is carried down to the link manager, as further explained later, for inclusion in the message transmission. This enables a corresponding software stack at the receiving node to present the message to a corresponding application through an isolation layer that establishes a second “virtual socket” consistent with the socket protocol used by the first application at the sending node. Consequently, the corresponding applications executing at both nodes appear, to each other, to be communicating over the selected socket protocol. In fact, the message may be modified and transmitted over a selected link using an entirely different protocol, but this change will be transparent to the application. Moreover, the link manager can choose multiple lengths for transmission of a given message, and spread the message over those links, so that the message is effectively transmitted like multiple messages, in parallel, over multiple communication links. Nonetheless, the various segments of the message are reassembled at the receiving node so that, again, a single message is presented at the virtual socket isolation layer as if none of this had occurred.

Again referring to FIG. 3, the next step 304 calls for determining the message type, size, priority, cost sensitivity, and security parameters, some or all of which may be used in connection with the security methods of the present invention as well as link choose logic implemented in the link manager. These characteristics or meta data do not require reading the actual message content or payload. In step 306, the system software formulate link choose parameters (LCP) based on the information acquired in step 304. The link choose parameters, LCP, can be passed down to the link manager component in various ways. For example, it can be appended to a message packet, or the LCP information can be passed to the link manager along separate signal path(s). The former method is indicated by the letter “A” as being appended, while the latter is indicated by a “P” indicating the information moves in parallel with the present message. Other techniques for passing this information to the link manager component will be known to those skilled in the software art, such as shared memory, assigned registers, and/or various software messaging techniques.

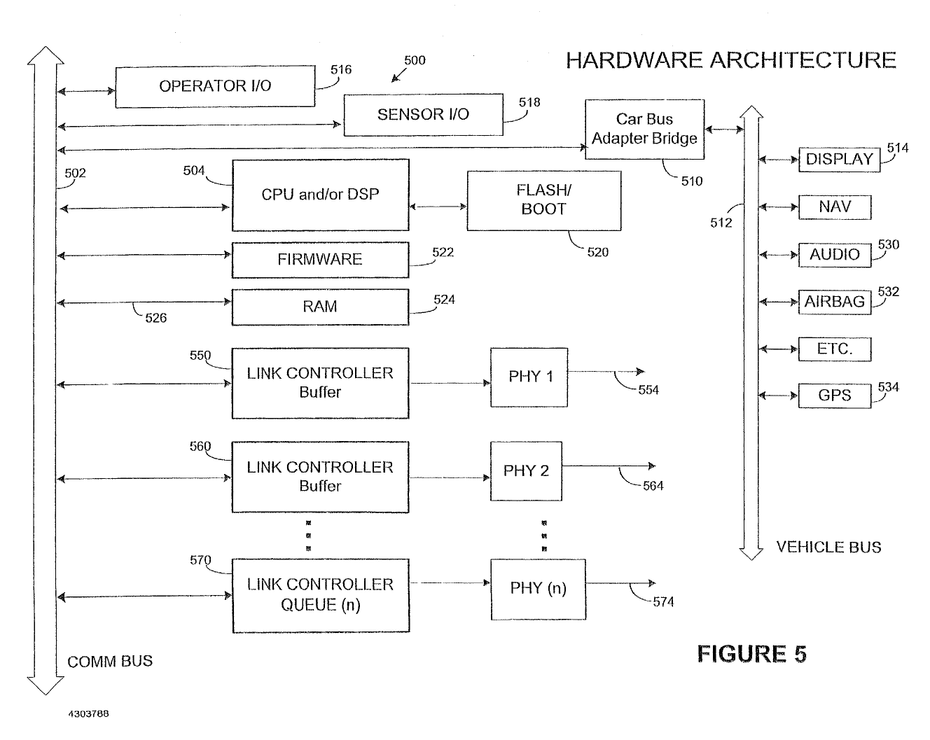

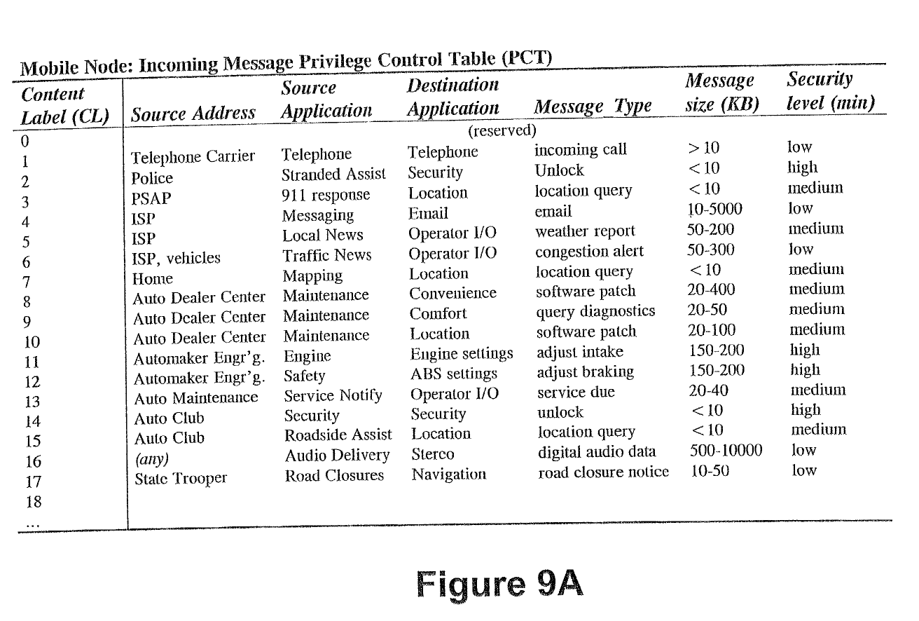

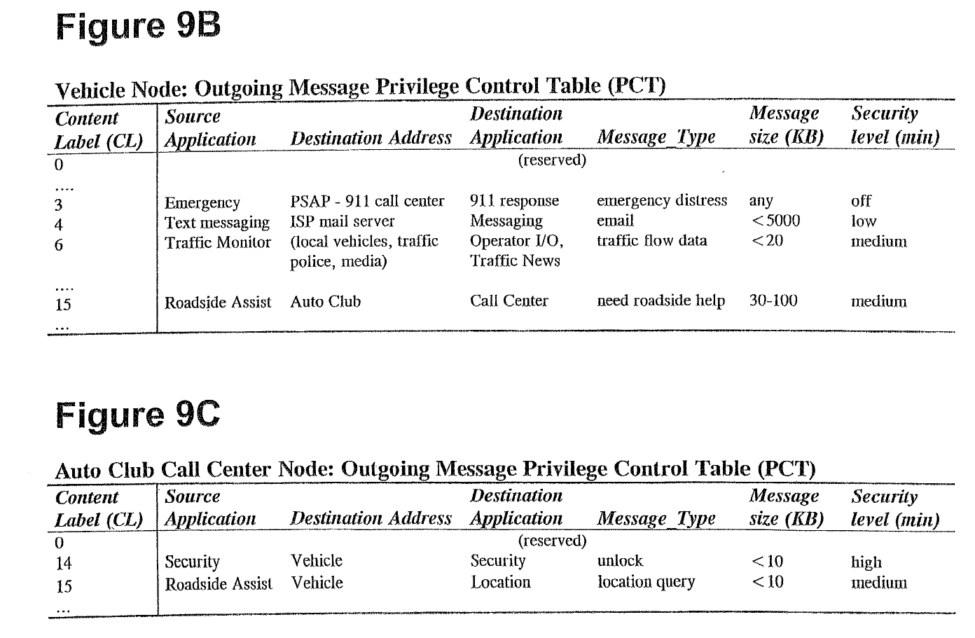

The next step 308 is for the system software to verify that the application sending the message is in fact authorized to send this particular type of message. This process is based upon a dynamic message privilege control table (PCT) described in detail later with reference to FIG. 9B. In step 310, the system software determines whether or not security measures are indicated. If not, control passes directly via 312 to the link manager software. The link manager at step 314 selects one or more channels or links for transmission of the message, as explained in greater detail below. The link manager may choose to partition or segment the message into multiple segments, each of which will be transmitted over a corresponding link. The link manager controls the link controllers, step 320, accordingly. In the case of an outbound message, as determined by decision 322, the link manager provisions the transport layer, step 324, for transmitting the message. A link controller (see FIG. 5) handles buffering and transmitting the outbound data, step 326, and then reports to the processor, either confirming transmission or flagging an error to initiate retransmission. Again, although these steps are illustrated serially in FIG. 3, the link manager can partition a message into multiple segments and send them in parallel over multiple communication links. This process is explained in greater detail with reference to FIGS. 2A, 2B and 2C.

Referring again to decision 310, if security measures are indicated for a given message, the security manager initializes a secure communication session, if one is not already active, step 350. This session is used to exchange information related to generating encryption keys. The security manager then encrypts the subject message, step 352, and attaches a content label to the encrypted message. It can also attach link choose parameters mentioned above. The encrypted message with a content label is passed to the link manager, step 354. As mentioned earlier, the link choose parameter information can be passed to the link manager either as a label appended to the message through alternative messaging to the link manager component.

In some cases, the link manager is called upon to configure a communication link for receiving a message. In this case, for an inbound message, the link manager provisions the corresponding link controller to receive a message, step 360, the corresponding link controller will then receive and buffer incoming data, step 362, and then report to the link manager, step 364. Again, the link controller may confirm receipt of a message, or flag an error to initiate retransmission.

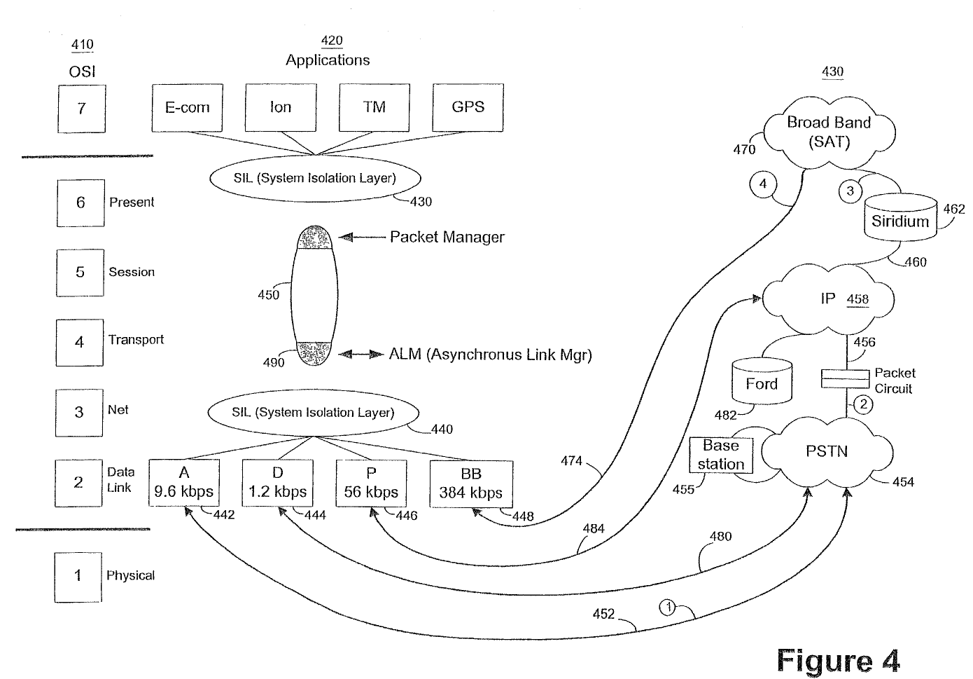

FIG. 4 is a conceptual diagram illustrating several aspects of the present invention. The left-side of the diagram refers to the seven layers of the OSI (open system interconnection) model. This is an ISO standard for worldwide communications that defines a framework for implementing protocols in seven layers. According to the OSI model, control is passed from one layer to the next, starting at the application layer in one station, proceeding to the bottom layer, over the channel to the next station and back up the hierarchy. Most of this functionality exists in all communication networks. The present invention departs from the classical OSI model in several respects as will be discussed. In the classic model, layer one is the physical layer, corresponding to a wire or cable in a wire network, and corresponding to a wireless channel in a wireless context. Layer 2 is the data link layer which generally is responsible for transmitting data from node to node. Layer 3, the network layer, routes data to different networks. Layer 4, the transport layer, generally insures delivery of a complete message. Thus it is charged with segmentation and reassembly of packets to form messages. Accordingly, the transport layer may need to track down any missing messages. Layer 5, the session layer, in general starts, stops and governs transmission order. Layer 6, the presentation layer, implements syntax for data conversion, and finally, layer 7 is the well-known application layer. As illustrated in FIG. 4, by way of example, applications can include e-commerce, GPS location services, telematics, voice communication, etc.

For the middle portion of FIG. 4, this conceptual diagram illustrates a first system isolation layer 430 just below the applications. A second isolation layer 440 is shown just above the OSI data link layer 2. At the data link level, FIG. 4 illustrates an analog modem (9.6 kbps) 442, a digital modem (1.2 kbps) 444, a packet modem (56 kbps) 446 and a broadband modem (384 kbps) 448. These channels are merely illustrative and other types of wireless links can be employed. It is expected that wireless data communication technologies will continue to evolve. One of the important benefits of the present system is that new links can be deployed without changing other aspects of the system, as further explained later, because of the system isolation layers. Similarly, at the top of the diagram, new applications can be deployed without changing the operating system software, generally indicated at 450, because it is logically isolated from the application layer, as well. The right-side of FIG. 4 illustrates, generally 430, some examples of application of the present system to form loosely coupled, ad hoc networks for communications. The term ad hoc is used here to refer to building a network loop, segment by segment, each segment comprising a separate communications. This ad hoc loop is formed as necessary and taken down when its task is completed. It is “loosely coupled” in the sense that multiple, distinct communications segments are involved in forming the loop. Each segment of the ad hoc loop comprises one or more communications sessions which, although inspired by receipt of a message from a preceding segment, comprise a distinct communication rather than a mere retransmission or routing of that preceding message.

FIG. 4 illustrates some examples of “loosely coupled,” ad hoc networking as follows. A first communication traverses a first link 462 using the analog modem link for 442 to reach the public switched telephone network (PSTN) 454. This segment would typically traverse a wireless bay station and wireless switching network (not shown). A “call taker” sender or bay station coupled to the PSTN (and not shown) can include a gateway for access to the Internet over a packet circuit 456. Thus, the bay station can initiate a second communication, or segment or our loosely coupled network, in response to the first communication via link 452. The second communication traverses the Internet 458 to a selected information server site over a link 460 (most likely a land line wired link). In this illustration, the information service provider called Siridium operates a server 462 for this purpose. Siridium, in turn, operates or contracts with a satellite-based or satellite-born broadband broadcasting system 470. The Siridium server 462, optionally after arranging for payment by the user, sends a message to the broadband satellite system 470. It may be necessary for the Siridium system to acquire requested data from another source (not shown). For example, the operator of our mobile system may have sent a request to download the potentially classic movie Top Gun. The Siridium server system 462 would acquire the movie content in digital form and transmit it (uplink) to the satellite system 470. The satellite system, in turn, broadcasts the video data indicated by link 474 to the requesting mobile unit, where it is received at the broadband receiver link 448. This last segment completes the loop of the ad hoc loosely coupled network. The onboard communication system then sends a message acknowledging receipt (or noting a problem), again via the analog modem 442. This message traverses segment 452, via the wireless and PSTN networks to the bay station 455. The bay station initiates a corresponding message, in response to the acknowledgment, and sends that message via link 456 through the Internet to the Siridium system 462. That system now posts the billing charge for the movie, if it was received successfully, or initiates rebroadcast of the movie if necessary.

FIG. 4 further illustrates another example in which an initial message might be sent over a digital modem 444 at 1.2 kbps, again via the PSTN 454. This message might be a request for nearby shopping or restaurant information, in other words, valet services. Which link is used to send this initial request is a matter of link choose logic further explained below. The valet services request on link 480 is received at the bay station 455. As before, the bay station initiates a second message, this time via the Internet (or via a land line crawl) to a selected information server, which in this example, might be provided by Ford Motor Company, in the form of a Ford valet server 482. In this case, the Ford server might respond by sending a HTML page comprising the requested information for display to the mobile user. The HTML page data can be transmitted back to the mobile unit, not in the same session as the initial request message, but in a separate communication session over a higher speed link, for example, link 484 which is received by a 56 kbps packet modem 446. This enables faster transmission of the HTML page content. If the packet modem link 446 corresponds, for example, to the link controller 560 on FIG. 5, that link controller may write the HTML data to RAM 524 via the communication bus 502, but in any event, the data can be transferred via the car bus adapter bridge 510 for display to the user via a dashboard display system 514. On the other hand, referring again to FIG. 4, if the communication system is merely sending routine operating data to Ford, it may choose to use the digital modem link 480 and the Ford system might acknowledge receipt of such data by a simple message over the control channel of a cell phone link. The selection of a link for outgoing messages is one of the functions of the asynchronous link manager (ALM) 490 described in greater detail later.

FIG. 5 is a simplified block diagram of a hardware architecture for implementing a communications system in accordance with the present invention in the context of a motor vehicle. In FIG. 5, the communications system 500 can be implemented in a wide variety of hardware architectures. By way of example only, FIG. 5 illustrates use of a communications bus 502 for carrying both address and data information as is typical of many microprocessor-based systems. This system includes a CPU and/or a DSP (digital signal processor) 504 coupled to the bus 502 for carrying out the operations described herein. More specifically, the processor 504 executes software which can be stored in a flash memory 520 or in a firmware memory 522 coupled to the bus 502. The flash memory 520 can include boot software for initializing the processor and can be used to store temporary variables in a nonvolatile manner. For example, the flash memory can be used to store encryption keys, “message of the day” and other messages related to security as described herein. A privileged control table can be stored in flash memory or downloaded as described elsewhere. Communication system 500 also includes random access memory 524 coupled via memory bus 526 to the communication bus 502 for temporary storage of data as necessary. For example, the RAM memory can be used for processing data packets, including encapsulating packets and extracting information from headers and other packet fields.

System 500 further includes an operator interface module 516 which can be used for interacting with an operator through keyboard, visual display, hands-free audio channel, etc. Alternatively, the communications system 500 can interact with the operator through the vehicle's existing driver interface systems. In such an embodiment, interactions with the user related to communications are transferred via a car-bus adapter bridge 510 to the vehicle bus 520. The adapter bridge 510 provides both electrical and logical transformations as necessary for communication between the communication bus and the vehicle bus. This enables the communication system to, for example, display messages to the operator via the dashboard display system 514 coupled to the vehicle bus 512. The adapter bridge 510 is also useful for coupling the communication system to the vehicle audio subsystem 530. Other vehicle subsystem such as the air bag system 532 and GPS system 534 are shown by way of example.

As one example of an interaction between a communications system 500 and other on-board vehicle systems, the communications system 500 can be used to download audio program content as described in greater detail below. As the audio content is received, decrypted, decoded, etc., the actual payload or audio data can be accumulated in RAM 524. The CPU 504 then transfers the audio content from RAM 524 via the communication bus 502 and the car bus adapter bridge 510 to the audio system 530 where it can be played on demand. Audio system 530 may in turn have its own memory system where the audio content can be stored for reuse at a later time without involving the communications system 500. Conversely, going the other direction, the vehicle audio system 530 in conjunction with the display system 514 can be used by an operator to input a request to download particular audio or video content to the vehicle. These instructions pass from the vehicle bus 512 via the adapter bridge 510 to the processor 504 for execution by the communications system. The communications system works interactively with the other on-board vehicle systems not only for entertainment, but to implement both transmission and receipt of critical data such as a 911 emergency message, as explained later.

Continuing an overview of the hardware architecture, the communications system 500 further includes a plurality of link controller modules, e.g., link controllers 550, 560 and 570. Each link controller controls operation of a corresponding communication link such as a analog modem link, a conventional cell phone link, a CDPD link, etc. Each of the link controllers is coupled to the communication bus 502 for interaction with the CPU 504 and RAM 524. Particularly for high-speed operation, such as a broadband download, the corresponding link controller may include buffer memory circuits, and hardware circuits for high-speed error-checking, error-correction and the like. Each link controller is coupled to a corresponding transceiver type of interface for connection to the physical layer, in this case a corresponding antennae. So, for example, link controller 550 is coupled to “PHY1” which may be an analog modem. PHY1, in turn, is connected to an antennae 554 similarly, link controller 560 is connected to PHY2, which in turn is connected to a second antennae 564. Each antennae preferably is an appropriate size and design for the frequencies applicable to the corresponding communication link. At least one link controller, say 570, can be connected through a corresponding physical interface to a conformal antennae 574. This refers to an antennae or antennae array that conforms to the shape of a portion of a vehicle such as the roofline, hood or spoiler, so that the antennae can be mounted adjacent or invisibly embedded within the corresponding vehicle body part. The CPU maintains multiple pointers into RAM memory 54 to accommodate simultaneous transfers of data (including headers, labels and payload) over multiple links. Each link controller provides status information to the CPU, for example, latency information or buffer size, which can be used to compute latency, for this operative to take into account in selecting a communication link. The link controller also indicates whether the corresponding link is currently available at all, which again must be taken into account in assigning communication links. Importantly, the present architecture or any functionally similar architecture can be used to “spread” a communication over a multiple simultaneous links. This should not be confused with spread spectrum transmission which is a commonly used technique for spreading data over multiple frequencies, such as in the widely used CDMA cell phone system. While spread spectrum spreads a signal over multiple frequencies, the signals nonetheless represent a single logical channel. For example, CDMA provides a one of 64 channeled coding for each frequency set. The present invention provides for spreading a given communication over two or more distinct communications links, each of which may employ different frequencies and/or different transfer rates.

FIG. 6 is a flow chart depicting steps performed in establishing a secure communication session between any two nodes operating the secure dynamic link allocation system of the present invention. For example, secure communication session initialization can occur between a mobile node operating on a motor vehicle and a call center node operated by a service provider such as an auto club, an automobile manufacturer, dealership, internet service provider, or another mobile node. With reference to FIG. 6, the security manager 158 (FIG. 1) first searches in a secure session log for the presence of encrypted variables corresponding to the destination identified in message 202 (FIG. 2A). (Step 610). If an entry exists in the secure session log, then sending node initiates an exchange of an encrypted session header stored in the secure session log (step 614) to verify and reestablish an active session represented by the encrypted section headers.

If encryptive variables are not saved in the secure session log or the encrypted session headers are not authenticated by both parties to the communication, then the security manager proceeds to initialize a new secure session beginning with the generation and exchange of new encryption keys (step 620). Encryption key exchange and generation of share of private keys is preferably formed using a shared private key generation alogorithm, such as Diffie-Hellman, which uses public keys exchanged by both parties and an alogorithm to generate a secret key common to both nodes that is based on both the exchange public keys and reserved private keys corresponding to each partie's public key. Both nodes then exchange digital signature algorithm messages and authenticate each other's messages 622 to verify the identity of the other node. Next, the node exchange software version and build number information 624, which is used by the nodes to determine a base PCT known to both nodes. For example, if a first node is operating system software version 5.2 and a second node is operating system software version 5.1, but both nodes have a stored PCT corresponding to system software version 5.0, the system security manager will negotiate this common version level and use the base PCT corresponding to that version level (and build number if appropriate). In the event where encryptive variables are stored in session log are exchanged between the nodes 614 and authenticated 616, the steps of key exchange and secret key generation 620, digital signature algorithm message exchange and authentication 622, and system software version and build number exchange 624 are bypassed.

Regardless whether a new secure session is being established, or a preexisting secured session is being reauthenticated, a base PCT is identified 626 and resequenced 628 so that content labels corresponding to the PCT entries are reordered or scrambeled to avoid intersception and spoofing of the content labeling and verification functions described above. To resequence the base PCT, the security manager uses the generated shared secret key in combination with a private resequencing algorithm defined in the system software version to generate reordering information that can be stored in a separate lookup table or resequencing function (step 628). Finally, the security manager completes initialization of secure session by storing the encrypted variables, digital signature, algorithm messages, and other session information in a secure session log that may be encrypted and made accessible only to security manager (step 630). Upon completion of secure session initialization and storage of encrypted variables, the software returns a secure session active status to security manager indicating readiness for encryption and transmission of messages.

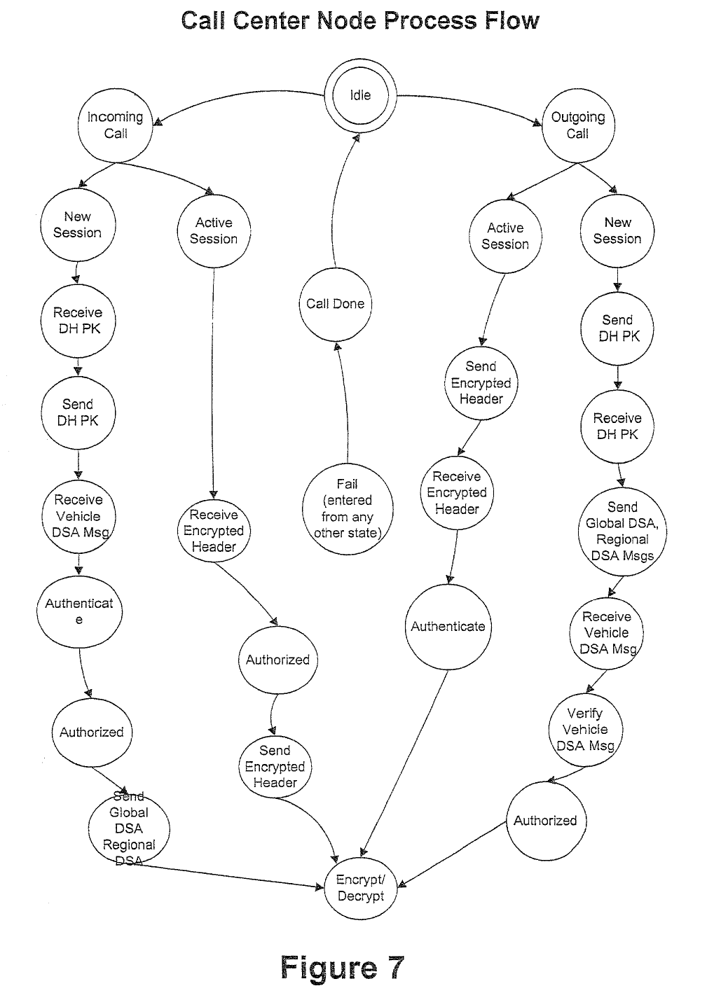

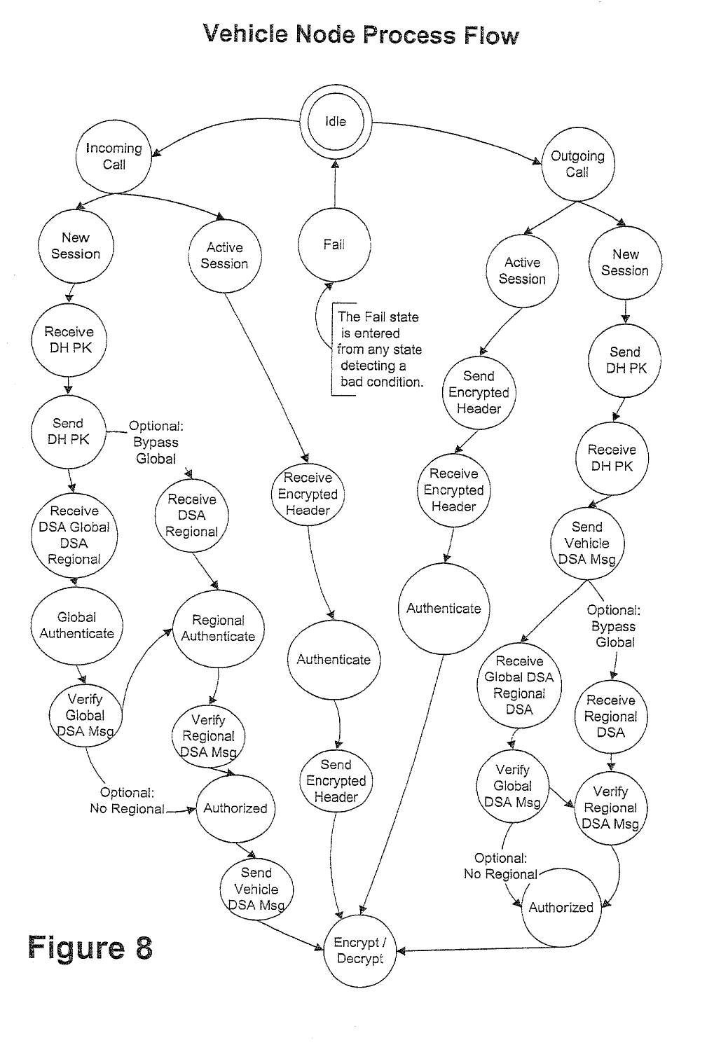

FIGS. 7 and 8 are flow charts depicting the steps of encryption key exchange 620 and digital signature authentication (DSA) 622 at respective call center and vehicle nodes, in a accordance with secure session initialization procedure 600 of FIG. 6. With reference to FIG. 7, upon receipt of an incoming call, the call center checks to determine whether the incoming call is a continuation of an active session with a known caller through receipt and authorization and response with encrypted secure headers prior to beginning encryption and decryption of messages. If an incoming call is not a continuation of an active session, a new session is established by exchange of Diffie-Hellman public keys (DH PK) and exchange and authentication of digital signature algorithm messages (DSA Msg), possibly including global and regional DSA messages relating to the region and domain served by the call center. If the call is an outgoing call generated by the call center an active session can be established by exchange of encrypted session headers and authentication by both the call center and vehicle site nodes prior to encrypted message transmission. Otherwise, a new session is established by exchange of Diffie-Hellman public keys (DH PK) exchange of DSA messages and verification. Content labeling resequencing is not depicted in FIG. 7, but would be performed prior to beginning encryption and decryption. As FIGS. 6 and 7 illustrate, the encryption, digital signature algorithm, content labeling and verification, and other security functions implement can be implemented in a modular fashion in security manager to progressively enhance security features of the secure dynamic link allocation system in accordance with the present invention. This architecture is particularly advantageous in the context of mobile devices, which are quickly improving in their data storage and processing capacities as a result of technoloogical improvements.

With reference to FIG. 8, the vehicle node security manager handles incoming and outgoing calls in a manner similar to call center node (FIG. 7). Optional bypass procedures are provided for handling the presence or absence of regional and global DSA messages for digital signature authentication of the call center, depending upon availability of call center DSA messages.

With reference to FIGS. 7 and 8, a fail state of the key exchange and authentication procedure is entered from any other state detecting a failure condition such as, for example, failure to receive an encryption key or digital signature message at any state during the key exchange and authentication process. Failure of the key exchange authentication process requires the nodes to restart the secure session and intialization process.

FIG. 9 is an example of a privilege control table (PCT) of a mobile node such as a vehicle for incoming messages received at the mobile node. FIG. 9B is a PCT for the mobile vehicle node for selected outgoing messages authorized for secure transmission from mobile node. FIG. 9C is an example of an outgoing message PCT stored at a call center node at an auto club call center. It will be understood that PCTs of FIGS. 9A, 9B, and 9C are exemplary only and are not intended to be comprehensive or limiting in nature.

With reference to FIG. 9A, mobile node incoming PCT includes multiple entries, each entry labeled with a content label such as a sequence of numeric identifiers. Content label, alternatively, could be represented by a memory pointer or other identifier of a record of the mobile node incoming PCT. Each record or entry of incoming PCT includes, in addition to the content label, a source address, a source application, a destination application, a message size, and a minimum security level. For example, content label 4 identifies an authorized Message—Type email having a size between 10 kilobytes and 5 megabytes a minimum security level of “low” that is received from an ISP messaging application and designated for delivery to an email application running in the application layer of the mobile node. Email messages that failed to satisfy all of the conditions identified in the PCT records will be denied delivery to the destination application and a message rejection reply will be sent to the source application by the security manager. For example, if the message size of the email is greater or less than the authorized message size, the verification procedures rejects the message to avoid delivery and execution of harmful messages on vehicle node. Content label provides an added layer of security (in addition to encryption and digital signature authentication) to thwart attacks attempt to spoof the mobile node's security manager into believing that the message is of a type listed in the PCT. Upon verification of content label, security manager determines a resequenced content label as described in FIG. 6 based on the base PCT content labels (FIG. 9A) and a stored algorithm of security manager that uses the shared private key. Preferably, the reordering algorithm is different from other security algorithms implemented by the vehicle node so that an attacker who has cracked the other security modules of the system does not have direct access to the reordering algorithm.

Various security levels (including a nonapplicable or “off” security level (not shown)) can be established in PCT and are used by the security manager and link manager of the sending node to determine security measures and link selection. By establishing minimum security level in the PCT, the secure dynamic link allocation system of the present invention avoids Trojan horse applications circumventing security measures through direct access to system communication functions, unless authorized by security manager and/or PCT. FIG. 9B is an example of a vehicle outgoing message PCT that includes an entry for an urgency distress message (content label=3) that can be of any message size and that can be transmitted without security measures, so long as the destination address of the emergency distress message is a public safety answering point (PSAP) (also known as a 911 call center), and provided that the source application is an emergency application recognized in PCT. With reference to FIG. 9C, a call center node of an auto club includes an outgoing message privilege control table with entries limited to those functions performed by the call center, such as automobile unlocking and location queries performed for roadside assistance purposes as a service to the vehicle owner and member of the auto club.

To prevent unauthorized access to vehicle, auto club is not provided with PCT information corresponding to functions such as vehicle settings, email, and telephone calling services. However, in the event that PCT entries corresponding to unauthorized functions are inadvertently included in a node's PCT, messaging would still remain unauthorized because an entry of the receiving node's PCT would not correspond to the unauthorized sender's source application and address information.

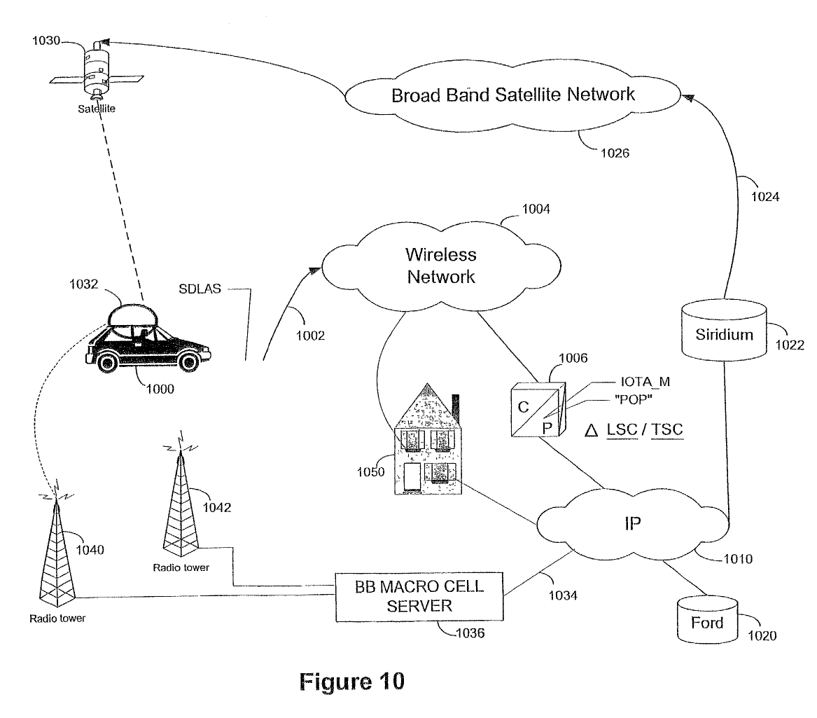

FIG. 10 further illustrates the link allocation and loosely coupled networking aspects of the present invention. In this illustration, a mobile unit, such as a car 1000, includes an on-board communication controller that implements a secure data-link allocation system in accordance with the present invention. In operation, the mobile user initiates a request message over a first link 1002 utilizing a low bandwidth channel, such as in-band signaling over a voice channel or digital data-link channel. This message is received by the wireless network, such as a conventional CDMA carrier 1004. The wireless carrier routes the message in accordance with a telephone number to a base station services controller 1006. The base station 1006 need not have a human operator present. It acts as a gateway, receiving request messages from the wireless network and, in response to those messages, creating and transmitting request messages using HTTP, e-mail or other Internet protocol for transfer over the Internet to a corresponding services provider. In this illustration, the provider 1020 is labeled “Ford” to generically represent an automobile manufacturer, although it could be a local dealer or agent, as well. The automobile maker 1020, based on the nature of the request, forwards it to an appropriate services provider. This segment of the loosely coupled network can be carried out over any type of available link. For some applications, a reasonably high bandwidth telephone or wired network connection may be used, or the Internet.

In another application of the present system, the mobile user 1000 sends a request for data or services, including within that request indicia of the present location of the mobile unit. This can be provided by a GPS receiver system deployed in the mobile unit. The location information can be carried as payload in a digital message or embedded in a voice channel over the wireless telephone network. In this case, a base station such as the server 1006 can take the location of the mobile unit into account in determining how to deliver the requested data or services. For example, if the mobile unit has a present location in the vicinity of one or more broadband transmission towers, a request message can be formed and transmitted via 1034 to a broadband macro cell server 1036. The message 1034 is transmitted via the Internet, though it could just as well be conducted over a land line modem or a wide area network. The broadband macro cell server 1036 assembles the requested data and dispatches it for wireless transmission, via a selected transmission tower such as 1040. If the vehicle is moving, subsequent message can be transmitted from the mobile unit to update its location. These updates can be forwarded to the macro cell server which, in turn, can activate additional radio transmission towers such as 1042.

The broadband macro cell may consist of a fixed location where wireless data is to be delivered. For example, a relatively short range broadband wireless transmitter could be used in a drive-through or parking lot arrangement for delivery of movie content. In that scenario, a user would simply drive the to movie store and order a desired movie through the dashboard user interface. A dynamic Internet address, based on location, can be resolved for deliver of the content. Alternatively, as described earlier, a channel code can be delivered directly to the mobile unit over a low speed connection for use in decoding the broadband transmission of content. These are additional examples of the use of loosely coupled networks, typically comprising a plurality of message segments, to achieve improvements in flexibility, efficiency, security and cost. Finally, FIG. 10 illustrates a house 1050 or other fixed location which can be coupled to the wireless network 1004 through the conventional PSTN or to the Internet 1010 through an Internet services provider (not shown), using a conventional DSL or cable connection. As the mobile user's home or office can be included in a variety of communications utilizing aspects of the present invention. For example, a coworker or relative at location 1050 may have no idea of the present location of a mobile user and, therefore, have no knowledge of what communications might be available to the mobile user at the present time. Further, the mobile unit might be at a location where a conventional cell phone service is unavailable. Notwithstanding the unavailability of telephone service, the mobile user can still employ e-mail/Internet messaging through the use of a location-based dynamic IP address as described.

The global positioning system offers any device a unique format and reference point on the planet. No two places on earth have the same location. By calculating the total population of unique addresses in terms of latitude and longitude at a resolution of 0.6 feet (e.g. −122 30.1255,45 28.3478), unique locations of approximately 2.16×1016 can be achieved. Methods are described in commonly-assigned U.S. patent application Ser. No. 09/432,818 filed Nov. 2, 1999, for generating a globally-unique, Internet protocol—(IPv4, IPv6) compatible addressing scheme based on location. With the recent announcements by wireless telecommunications handset providers of the inclusion of GPS receivers in their products, and the deployment of GPS receivers in automobiles, the necessary global position data will be readily available in many mobile units.

More specifically, the prior application describes a paradigm shift in network architecture. The addressing scheme described there is backward compatible with existing networks and protocols, but it leverages them in a new way. Conventionally, mobile devices like a wireless phone or laptop computer were thought of as “clients” in a network architecture, and communications software or “stacks” were arranged accordingly. The clients would communicate with and through a server. Initially, the server or host would assign an IP address to the client. (Typically using DHCP—the Dynamic Host Configuration Protocol.) Then the client could communicate with the rest of the world, through that server, using the assigned address. The server, acting as a gateway, would receive packets from the client, repackage them (encapsulate), and send them onto the broader network. That arrangement is not convenient, and in some situations impossible, for mobile units.

The earlier application upends this conventional arrangement. According to that invention, it is the mobile “client” or end user device that assigns its own IP address, rather than look to a server or host for that function. Thus we define a new DCCP: Dynamic Client Configuration Protocol. The client now acts as a server in that it can communicate directly onto the larger network, even the Internet, reducing the number of intermediate machines. Thus, this newly independent client, having assigned its own IP address (based on global location), can emulate a gateway or router, encapsulating its own packets as it chooses. Addresses are resolved from the client up, rather than from the host down as in prior art. This new paradigm has remarkable potential to traverse the Internet much faster than the prior art systems, driving communication latency and overhead far below present levels.

In the context of the present invention, the modified stack accesses global position data from a GPS application at the session layer. That information is used to form an IP address, which in turn allows communications between the mobile unit and the Internet (i.e. other nodes connected to the Internet), without relying on a wireless carrier acting as an intermediary, and potentially adding to the cost of such access. Instead of exchanging short messages with the wireless carrier, and having the wireless carrier access the Internet to get information for the user, the mobile user is afforded direct access.

It will be obvious to those having skill in the art that many changes may be made to the details of the above-described embodiments of this invention without departing from the underlying principles thereof. The scope of the present invention should, therefore, be determined only by the following claims.

1. A method for layered secure communications involving at least one mobile unit, the mobile unit hosting at least one application program and the application program sending a message having associated with it a source application, a destination application and a message type, the method comprising the steps of:
establishing a base privilege control table comprising a series of entries, each entry in the table indicating a permitted class of messages corresponding to a predetermined combination of a selected sending application, a selected destination application and a selected message type;
providing a series of content labels;
associating each of the content labels to at least one entry in the privilege control table;
examining the message to determine the type of the message without reading the payload of the message;
determining whether the message is permitted or not by reference to the privilege control table; and
if the message is permitted by the privilege control table, adding the associated content label to the message and approving the message for transmission to the destination application.

2. A method according to claim 1 further comprising changing the association between the content labels and the entries of the privilege control table.

3. A method according to claim 1 and further including:
isolating the application program by providing a protocol manager for exclusive receipt of a communication service request from the application program; the protocol manager implementing a plurality of different message protocols for establishing corresponding virtual socket connections with various application programs; and
protocol labeling the message before transmission of the message, the protocol label including an indicator of a protocol type of the virtual socket connection over which the application sent the message, so as to facilitate establishing a corresponding virtual socket connection with the destination application.

4. A method according to claim 3 and further including encrypting the protocol labeled message before transmission of the message.

5. A method according to claim 4 wherein the destination application executes on a destination node and said encrypting step includes establishing a secure session with the destination node including exchanging encryption keys.

6. A method according to claim 3 and further comprising the steps of:
providing a plurality of communication link controllers, each communication link controller coupled to a corresponding wireless transmitter;
segmenting the message into a plurality of message segments; and
assigning each of the message segments to a different selected one of the communication link controllers for transmission over the corresponding transmitter, thereby enhancing security of transmission of the message.

7. A method according to claim 6 wherein said assigning step is based at least in part on a security level indicated by the sending application.

8. A method according to claim 6 wherein said assigning step is based at least in part on a cost sensitivity indicated by the sending application.

9. A method according to claim 6 wherein said assigning step is based at least in part on the type of the message.

10. A loosely-coupled, ad hoc network loop communications method for broadband delivery to a mobile unit comprising the steps of:
providing a mobile unit with wireless communications capability;
transmitting a first wireless message from the mobile unit to a base station via a first link, the first message including indicia requesting selected data for transfer to the mobile unit, and the first link having a predetermined data transfer rate;
at the base station, receiving the first message, and forming a second message responsive to the first message, the second message including an identifier of the mobile unit;
transmitting the second message from the base station to a selected information server over a second link, the second link having a data transfer rate greater than the first link;
at the selected information server, receiving the second message and, responsive to the second message, initiating transmission of the selected data to the requesting mobile unit via a broadband wireless broadcast link having a data transfer rate greater than the second link; and
In the mobile unit, receiving the selected information over a receive-only channel adapted to receive data from a broadband wireless broadcast, whereby the mobile unit receives the requested data at a higher transfer rate than the transfer rate of the first link on which the first message was sent requesting the selected data.

11. A method according to claim 10 wherein the first link comprises a wireless voice call, and the first message is sent by voice; and wherein said receiving the first message at the base station includes forming digital data responsive to automated recognition of the voice message.

12. A method according to claim 10 wherein the first link comprises a wireless voice call, and sending the first message comprises sending digital data within the voice channel during the voice call.

13. A method according to claim 12 wherein said sending digital data within the voice channel comprises a blank and burst technique.

14. A method according to claim 10 wherein the second link comprises a telephone land line.

15. A method according to claim 10 wherein said initiating transmission of the selected data comprises forming a third message responsive to the second message and sending the third message to a satellite service provider SSP to initiate transmission of the selected data from a satellite-borne broadband transmitter to the requesting mobile unit without the use of any special wireless application protocol.

16. A method according to claim 10 wherein the information server initiates a charge to a predetermined account associated with the requesting mobile unit to pay for delivery of the selected data.

17. A method according to claim 10 wherein the information server further communicates with the requesting mobile unit to arrange payment for delivery of the selected data.

18. A method according to claim 10 wherein said initiating transmission of the selected data comprises forming a third message responsive to the second message and sending the third message to a broadband macro cell service provider BMSP to initiate transmission of the selected data from at least one broadband macro cell transmitter to the requesting mobile unit.

19. A method according to claim 10 wherein the base station transmits the second message to the information server via the Internet.

20. A loosely-coupled network loop communications method for broadband delivery to a mobile unit comprising the steps of:
providing the mobile unit with wireless communications capability and GPS location capability;
transmitting a first wireless message from the mobile unit to a base station via a first link, the first message including indicia requesting selected data for transfer to the mobile unit and further including indicia of a present location of the mobile unit, and the first link having a predetermined data transfer rate;
at the base station, receiving the first message, and forming a second message responsive to the first message, the second message including an identifier of the mobile unit and indicia of the present location of the mobile unit;
transmitting the second message from the base station to a selected information server over a second link, the second link having a data transfer rate greater than the first link; and
at the selected information server, receiving the second message and, responsive to the second message, initiating transmission of the selected data from a selected transmission facility to the requesting mobile unit via a broadband wireless broadcast link having a data transfer rate greater than the first and second links, thereby forming an ad hoc, loosely coupled network loop comprising the mobile unit, the base unit, the information server and the broadband wireless transmission facility.

21. A method according to claim 20 wherein said transmitting the second message from the base station to a selected information server includes selecting an information server based on the indicia of the present location of the mobile unit.

22. A method according to claim 20 further comprising the steps of: at the base station, determining a code for decoding the selected data to be transmitted to the requesting mobile unit via the broadband wireless broadcast link; and sending the said code via a message over the first link to the mobile unit.

23. A method according to claim 22 further comprising the steps of: at the mobile unit, receiving the requested data via the broadband wireless broadcast link by using the code received from the base station via the first link.

24. A method according to claim 20 wherein the selected transmission facility includes at least one fixed location BMC transmitter.

25. A method according to claim 20 wherein the selected transmission facility includes at least one satellite transmitter.

26. A method according to claim 20 wherein the selected data requested by the mobile unit comprises video data.

27. A method according to claim 20 and further comprising: forming a completion message in the mobile unit responsive to successful receipt of the requested data;
transmitting the completion message via the first link to the base station;
and then, in the base station, transmitting a corresponding completion message to the selected information server, thereby completing the requested transaction via the network loop.

28. A method according to claim 20 wherein the mobile unit is coupled to a motor vehicle and the selected data requested by the mobile unit comprises navigation data.

29. A method according to claim 20 wherein the mobile unit is coupled to a motor vehicle and the selected data requested by the mobile unit comprises vehicle systems software.
